(19) United States
(12) Patent Application Publication
(10) Pub. No.: US 2004/0178601 A1
(43) Pub. Date: Sep. 16, 2004

(54) Strut side loading double wound torsion spring

(76) Inventors: Joseph A. Fader, Brighton, MI (US); Steven G. Saieg, Sterling Heights, MI (US); Steven J. Doyle JR., Northville, MI (US); Monte G. Williams, Royal Oak, MI (US); Marlon V. Bottene, Rochester Hills, MI (US); George N. Lasic, Brampton (CA); Thomas R. King, Milton (CA)

Correspondence Address: CARLSON, GASKEY & OLDS, P.C., 400 WEST MAPLE ROAD, SUITE 350, BIRMINGHAM, MI, 48009, US

(21) Appl. No.: 10/387,798

(22) Filed: Mar. 13, 2003

(51) Int. Cl. B60G 11/50

(52) U.S. Cl. 280/124.165

(57) ABSTRACT

A suspension assembly comprises a strut mounted on a vehicle body for supporting a wheel. A first seat is mounted on the vehicle body. A first spring is mounted between the first seat and a second seat and has a coil wherein the coil extends a long a first axis. A second spring applies a biasing force to the strut along a second axis transverse to the first axis. The second spring is operatively connected to the vehicle body and the strut.

### BACKGROUND OF THE INVENTION

This invention relates to a strut assembly for a motor vehicle.

Strut assemblies for a motor vehicle typically comprise a strut and spring. The spring is frequently a helical coil spring coiled around the strut, which may comprise a rod and piston disposed in a cylinder providing a McPherson strut configuration. The rod telescopes relative to the cylinder. The strut interconnects the vehicle frame to a wheel of the vehicle and the spring serves to cushion vibrations experienced by a wheel attached to the strut, while the strut serves to dampen the force experienced by the spring.

As a consequence of forces from the road on the wheel and the positioning of the strut assemblies and spring, the strut may experience a force lateral to the direction of the telescoping movement of the rod and cylinder. This force increases friction at the sealing interface between the piston and cylinder, causing the strut to telescope in less than optimal fashion.

One way of addressing the lateral load is to alter the shape of the helical coil spring. The coil spring may be curved to create a force opposite the lateral load at the sealing interface. However, altering the shape of the mainspring shock may not only be difficult but may produce insufficient results to address the unwanted lateral load.

Another way of solving this problem is to angle the coil spring relative to the direction of oscillation for the strut. By inclining the spring relative to the strut, a lateral force is introduced at the sealing interface between piston and cylinder to help offset the creation of friction at this point. However, due to the angling of the spring relative to the strut, a heavier spring is required to provide the necessary spring force along the direction of travel of the piston within the cylinder. Such a design adds size and weight to the spring in an area of limited space.

A need therefore exists for a strut assembly that offsets the lateral force experienced at the sealing interface of the strut without increasing the size and weight of the spring.

### SUMMARY OF THE INVENTION

The inventive strut assembly reduces the load on a main shock spring by using another spring to create a force lateral to the direction of extension of the vehicle strut. This force counteracts the force experienced by the strut at the piston and cylinder. The assembly has a strut extending along an axis. A first spring compresses along the strut to alleviate road shock on the vehicle tire. A second spring applies a biasing force lateral to the strut to offset any force experienced by the strut at the sealing interface. This second spring is easier to implement and may be tailored to address only the problem of side loading.

The second spring may be a double wound torsion spring. One portion of the double wound torsion spring may pivot relative to the second portion of the double wound torsion spring. Spring energy is stored between the two portions and released in the form of a biasing force across the strut. This biasing force offsets the force experienced by the strut assembly on the strut due to its geometry.

The strut assembly may have a control arm connecting the lower portion of the strut to the vehicle. A portion of the second spring may act as the control arm, thereby reducing the number of parts for the assembly. In such an instance, the portion of the spring is then pivotally connected to the strut.

The inventive suspension assembly may be employed with known McPherson strut assemblies. The McPherson strut may comprise a telescoping rod and cylinder strut design with a helical coil spring disposed around the strut. Another spring, such as the double wound torsion spring, is used to counter lateral load on the strut.

The invention thus permits the use of a smaller and lighter spring to act as the main spring to counter road shock. The other spring serves to offset forces lateral to the strut. The assembly is inexpensive and provides effective protection against side loading of the strut.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates the inventive strut assembly, showing first spring and second spring.

FIG. 2 illustrates the inventive strut assembly, highlighting the use of second spring as a control arm.

### DETAILED DESCRIPTION OF THE PREFERRED EMBODIMENT

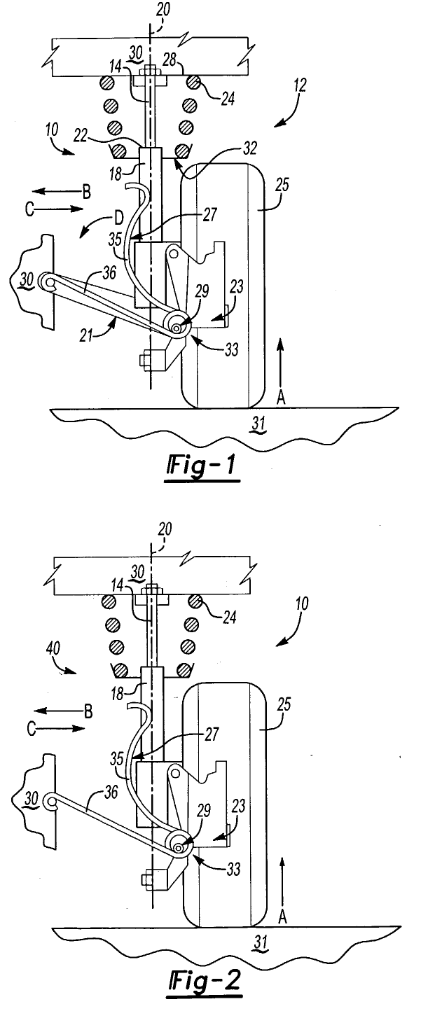

FIG. 1 illustrates the inventive strut assembly 12. As shown, strut 10, here a McPherson strut, comprises rod 14 nested within cylinder 18. Rod 14 is connected to piston (not shown), which is sealed by sealing interface 22. Rod 14 is operatively connected to vehicle body 30 and telescopes along axis 20 relative to cylinder 18. Cylinder 18 is pivotally connected to control arm 21 at knuckle 23. Control arm 21 is operatively connected to vehicle body 30. Wheel 25 is connected to strut 10 and control arm 21.

During movement of the vehicle, wheel 25 experiences an upward force along arrow A from ground 31 caused by the weight of the vehicle. This force creates a lateral force along arrow B due to the angle of the strut relative to the ground at sealing interface 22. This lateral force causes rod 14 to experience friction in its movement within cylinder 18 at sealing interface 22. As a consequence, rod 14 may not oscillate smoothly along axis 20. Because spring 24 is a helical spring 24 having a centerline extending along axis 20, helical spring 24 provides little assistance in offsetting lateral force in the direction of arrow B.

In contrast to known strut assemblies, strut assembly 12 has second spring 27 to offset force along arrow B at sealing interface 22. Second spring 27 comprises first member 35 and second member 36. First member 35 is pivotally connected to second member 36 at pivot 33 such that compression of first member 35 toward second member 36 along arrow D stores potential energy, which may be released in the form of force along arrow C.

Second spring 27 may comprise a double wound torsion spring. The second member 36 may be mounted to control arm 21 with pivot 33 of first member 35 and second member 36 wound around and connected to link 29 between control arm 21 and knuckle 23. Pivot 33 may also be connected about the clevis region, which is the u-shaped connection between strut 10 and control arm 21. First member 35 may be mounted to strut 12 just beneath sealing interface 22 as shown.

In operation, load from ground 31 on vehicle tire 25 creates force along arrow B, at sealing interface 22. Force along arrow B is offset by second spring 27, which creates a lateral force along arrow C opposite in direction to the force along arrow B when first member 35 compresses relative to second member 36. In this way, load on strut 10 is passed to second spring 27, which is specifically designed to offset load along arrow B. Accordingly, strut assembly 12 avoids the use of a heavier, larger coil spring in an area where space may be limited.

Strut assembly 40 of FIG. 2 is similar to strut assembly 12 of FIG. 2. However, in this variation, strut assembly 40 employs second member 36 as the control arm by attaching second member 36 to vehicle body 30 as shown, eliminating the need for a separate control arm. Second member 36 is mounted to vehicle body 30 and to knuckle 23. First member 35 is compressible about pivot 33 to provide a resisting force along arrow C laterally across axis 20.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. A suspension assembly comprising:
a strut mounted on a vehicle body for supporting a wheel;
a first seat mounted on said vehicle body;
a first spring mounted between said first seat and a second seat, having a coil wherein said coil extends along a first axis; and
a second spring applying a biasing force to said strut along a second axis transverse to said first axis, said second spring operatively connected to said vehicle body and said strut.

2. The suspension assembly of claim 1 wherein said second spring comprises a first member pivotally compressible with a second member, said first member applying said biasing force.

3. The suspension assembly of claim 2 wherein said second spring comprises a double wound torsion spring.

4. The suspension assembly of claim 2 including a control arm pivotally connected to said strut.

5. The suspension assembly of claim 4 wherein said first member is mounted to said strut and said second member is mounted to said control arm.

6. The suspension assembly of claim 4 wherein said second member acts as a control arm for a vehicle, said second member pivotally connected to said strut.

7. The suspension assembly of claim 1 wherein said strut comprises a rod disposed in a cylinder having a sealing interface between said rod and said cylinder and said biasing force offsets an opposing force experienced at said sealing interface.

8. A suspension assembly comprising:
a strut extending along an axis; and
a torsion spring applying a biasing force transverse to said axis wherein said torsion spring comprises a first member pivotally compressible with a second member, said first member applying said biasing force to said strut.

9. The suspension assembly of claim 8 wherein said second member supports said strut.

10. The suspension assembly of claim 8 wherein said second spring comprises a double wound torsion spring.

11. The suspension assembly of claim 8 wherein said first member is mounted to said strut and said second member is mounted to a vehicle frame.

12. The suspension assembly of claim 11 wherein said second member acts as a control arm for a vehicle.

13. The suspension assembly of claim 8 wherein said strut comprises a rod disposed in a cylinder having a sealing interface between said rod and said cylinder and said biasing force offsets an opposing force experienced at said sealing interface.

14. The suspension assembly of claim 8 including a coil spring extending along said axis.

15. The suspension assembly of claim 14 including a first seat mounted to said strut and a second seat mounted to a vehicle, said coil spring mounted between said first seat and said second seat.

16. A method of suspension for a vehicle wheel assembly;
pivotally compressing a first member relative to a second member;
storing spring energy between the first member and the second member;
releasing the spring energy by decompressing the first member relative to the second member;
applying a biasing force from the spring energy to a strut along a direction lateral to the extension of the strut; and
offsetting an opposing force with the biasing force.

17. The method of suspension of claim 16 wherein the strut comprises a rod disposed in a cylinder having a sealing interface between the rod and the cylinder and the biasing force offsets an opposing force experienced at the sealing interface.

18. The method of suspension of claim 16 including the step of supporting the strut through the second member.
